(19) United States
(12) Patent Application Publication
(10) Pub. No.: US 2011/0201528 A1
(43) Pub. Date: Aug. 18, 2011

(54) Methods Of Forming An Oligomer Array

(76) Inventors: Se-Kyung Baek, Hwaseong-si (KR); Joo-Hyeon Park, Cheonan-si (KR); Hyo-Jin Yun, Anyang-si (KR); Hyun-Sang Joo, Daejeon (KR); Ran-Ra Park, Asan-si (KR); Sung-Ouk Jung, Hwaseong-si (KR); Ji-Yun Ham, Seongnam-si (KR)

(21) Appl. No.: 13/030,890

(22) Filed: Feb. 18, 2011

(30) Foreign Application Priority Data
Feb. 18, 2010 (KR) 2010-0014590

(51) Int. Cl. C40B 50/18

(52) U.S. Cl. 506/32

(57) ABSTRACT

The present invention provides compositions for forming an oligomer array and methods for using the same. Such a composition may include an acid stable polymer, a photoacid generator and an organic solvent and may allow for the selective attachment of oligormers at one or more desired positions on a substrate using long wavelength light.

### CROSS-REFERENCE TO RELATED APPLICATION

This application claims priority under 35 USC §119 to Korean Patent Application No. 2010-0014590, filed on Feb. 18, 2010, the contents of which are herein incorporated by reference in their entirety.

### FIELD OF THE INVENTION

The present invention relates to compositions for forming an oligomer array and methods of forming an oligomer array.

### BACKGROUND

Biochips using biomaterials (or analogues thereof) as probes are widely used for diagnosing cancer or genetic diseases, detecting mutations or pathogens, analyzing genetic expressions and/or designing new medicines. Such biochips may be formed by attaching oligomers including a plurality of nucleotides, peptides or the like to a substrate having an area less than about one square inch.

Biochips may be formed by a photolithography process. In a biochip manufacturing process, oligomers may be formed at one or more desired positions on a substrate by coating the substrate with a composition including a photoacid generator may be coated on a substrate to form a layer, and portions of the layer may be selectively exposed to light (e.g., by using a mask to create exposed/unexposed portions of the layer), thereby allowing for the formation of oligomers at one or more desired positions on the substrate. However, if acid generated by the photoacid generator does not diffuse easily through the layer, oligomers may not be formed at the desired position(s) on the substrate. On the other hand, if the acid diffuses to unexposed portions of the layer, oligomers may be formed at undesired positions on the substrate. Additionally, if the composition (or the photoacid generator in the composition) has a low absorbance, light having a short wavelength may be required, and the oligomers and/or monomers attached to the substrate may be damaged. Moreover, if the composition has a low solubility in an organic solvent, the layer may not be easily removed following the exposure step, and residue may remain on the substrate.

### SUMMARY

Example embodiments of the inventive concept provide a composition for forming an oligomer array, wherein oligomers may be formed at one or more desired positions on a substrate without damaging the oligomers.

Example embodiments of the inventive concept provide a method of forming an oligomer array, wherein oligomers may be formed at one or more desired positions on the substrate without damaging the oligomers.

### Compositions for Forming an Oligomer Array

In accordance with an aspect of the inventive concept, a composition for forming an oligomer array may comprise a polymer, a photoacid generator and an organic solvent. In some embodiments, the polymer is an acid-stable polymer.

In example embodiments, the polymer may comprise repeating units represented by Chemical Formulae 1 and 2:

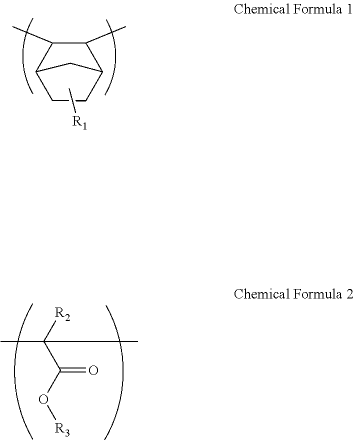

In Chemical Formula 1, R₁ may be stable to acid and may represent hydrogen, a C₁-C₂₀ alkyl group, a C₃-C₂₀ cycloalkyl group, a C₂-C₂₀ alkoxy alkyl group or a C₅-C₂₀ alkoxy cycloalkyl group. In Chemical Formula 2, R₂ may be stable to acid and may represent hydrogen, a C₁-C₂₀ alkyl group or a C₂-C₂₀ alkoxy alkyl group, and R₃ may be stable to acid and may represent a C₃-C₂₀ cyclo alkyl group or a C₃-C₂₀ lactone group.

In example embodiments, the polymer may be represented by Chemical Formula 3,

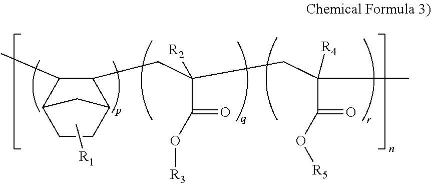

In Chemical Formula 3, R₁ may be stable to acid and may represent hydrogen, a C₁-C₂₀ alkyl group, a C₃-C₂₀ cycloalkyl group, a C₂-C₂₀ alkoxy alkyl group or a C₅-C₂₀ alkoxy cycloalkyl group. R₂ and R₄ may be stable to acid and each independently may represent hydrogen, a C₁-C₂₀ alkyl group or a C₂-C₂₀ alkoxy alkyl group. R₃ and R₅ may be stable to acid and each independently may represent a C₃-C₂₀ cycloalkyl group or a C₃-C₂₀ lactone group. P may be in a range of about 0.1 to about 0.3. Q may be in a range of about 0.2 to about 0.5. R may be in a range of about 0.2 to about 0.5. P, q and r may satisfy the equation p+q+r=1, and n may be a positive integer in a range of about 10 to about 400.

In example embodiments, the polymer may be represented by Chemical Formula 4,

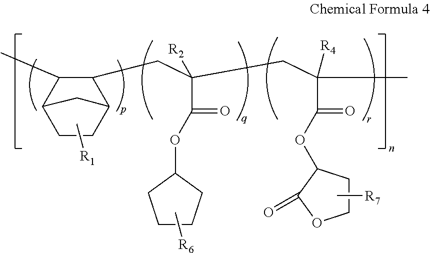

In Chemical Formula 4, R₁ may be stable to acid and may represent hydrogen, a C₁-C₂₀ alkyl group, a C₃-C₂₀ cycloalkyl group, a C₂-C₂₀ alkoxy alkyl group or a C₅-C₂₀ alkoxy cycloalkyl group. R₂ and R₄ are stable to acid and each independently may represent hydrogen, a C₁-C₂₀ alkyl group or a C₂-C₂₀ alkoxy alkyl group. R₆ and R₇ may be stable to acid and each independently may represent hydrogen, a C₁-C₁₀ alkyl group or a C₂-C₁₀ alkoxy alkyl group. P may be in a range of about 0.1 to about 0.3. Q may be in a range of about 0.2 to about 0.5. R may be in a range of about 0.2 to about 0.5. P, q and r may satisfy the equation p+q+r=1, and n may be an integer in a range of about 10 to about 400.

In example embodiments, the photoacid generator may be represented by Chemical Formula 5,

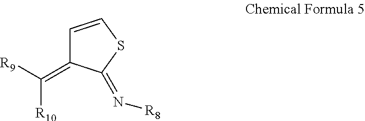

In Chemical Formula 5, R₈ may represent a sulfonate group or an acetate group. R₉ and R₁₀ each independently may represent a C₁-C₂₀ alkyl group, a nitrile group, a C₂-C₂₀ alkoxy alkyl group, a nitro group, a C₄-C₂₀ aryl group, a C₃-C₂₀ cycloalkyl group or a C₅-C₂₀ alkoxy cycloalkyl group.

In example embodiments, the photoacid generator may be represented by Chemical Formula 6,

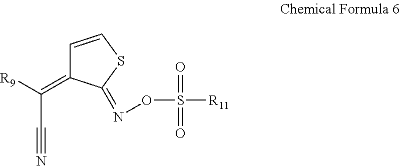

In Chemical Formula 6, R₉ may represent a C₁-C₂₀ alkyl group, a C₂-C₂₀ alkoxy alkyl group, a nitro group, a C₄-C₂₀ aryl group, a C₃-C₂₀ cycloalkyl group or a C₅-C₂₀ alkoxy cycloalkyl group. R₁₁ may represent a C₁-C₂₀ alkyl group, a C₂-C₂₀ alkoxy alkyl group, a C₃-C₂₀ cycloalkyl group, a C₅-C₂₀ alkoxy cycloalkyl group, a C₃-C₂₀ carbonyl group, a C₂-C₂₀ ether group, a C₃-C₂₀ ester group or a C₄-C₂₀ aryl group.

In example embodiments, the organic solvent may comprise propylene glycol monomethyl ether acetate, propylene glycol ether, cyclohexanon, ethyl lactate, butyl lactate, 1,4-dioxane, dichloromethane, ethyl acetate, acetonitrile, ethyl ether or any combination thereof.

In example embodiments, the composition may include about 1% to about 20% by weight of the polymer, about 1% to about 20% by weight of the photoacid generator and about 60% to about 98% by weight of the organic solvent.

In example embodiments, a weight-average molecular weight of the polymer may be in a range of about 1,000 g/mol to about 50,000 g/mol.

In example embodiments, a molecular weight distribution of the polymer may be in a range of about 1.2 to about 5.0.

In example embodiments, a glass transition temperature of the polymer may be in a range of about 50° C. to about 180° C.

### Methods for Forming an Oligomer Array

In accordance with another aspect of the inventive concept, a method of forming an oligomer array may comprise attaching a first molecule comprising an acid-labile group to a substrate and converting the first molecule into a second molecule by removing the acid-labile group from the first molecule.

The first molecule comprising the acid-labile group may comprise, but is not limited to, a phosphoramidites, a nucleotide, a ribonucleotide, an amino acid, a monosaccharide, a peptide nucleic acid (PNA) monomer, a locked nucleic acid (LNA) monomer, a glycol nucleic acid (GNA) monomer, a threosome nucleic acid (TNA) monomer or any combination thereof.

The acid-labile group may comprise dimethoxytrityl (DMT), triphenylmethyltrityl or tert-butyloxycarbonyl.

In example embodiments, a first molecule comprising an acid-labile group may be attached to the substrate directly or indirectly (i.e., one or more linker/spacer molecules may be interposed between the substrate and the first molecule comprising the acid-labile group).

In example embodiments, a first molecule comprising an acid-labile group may be attached to the substrate as follows:
1. The first molecule comprising the acid-labile group may be directly attached to the substrate.
2. A linker molecule may be attached to the substrate. The linker molecule may be reacted with a compound comprising the acid-labile group to convert the linker molecule into the first molecule comprising the acid-labile group.
3. A linker molecule may be attached to the substrate. The first molecule comprising the acid-labile group may be indirectly attached to the substrate by forming a chemical bond between the first molecule comprising the acid-labile group and the linker molecule.
4. A linker molecule may be attached to the substrate. The linker molecule may be reacted with a spacer molecule comprising a light-labile group and a functional group capable of forming a chemical bond with a compound comprising the acid-labile group. The spacer molecule's functional group may be exposed by removing the light-labile group from the spacer molecule (e.g., by exposing the substrate to light). A compound comprising the acid-labile group may be reacted with the spacer molecule's functional group to convert the linker-spacer compound into the first molecule comprising the acid-labile group.
5. A linker molecule may be attached to the substrate. The linker molecule may be reacted with a spacer molecule comprising a light-labile group and a functional group capable of forming a chemical bond with the first molecule comprising the acid-labile group. The spacer molecule's functional group may be exposed by removing the light-labile group from the spacer molecule (e.g., by selectively exposing portions of the substrate to light). The first molecule comprising the acid-labile group may be indirectly attached to the substrate by forming a chemical bond between the first molecule comprising the acid-labile group and the spacer molecule's exposed functional group.
   In some such embodiments, the light-labile group may comprise oxycarbonyl (NPPCC), methyl-nitropiperonyloxycarbonyl (MeNPOC), o-nitrophenylcarbonyl, p-phenylazophenylcarbonyl, phenylcarbonyl, p-chlorophenylcarbonyl, 9-floureneylmethyloxycarbonyl (Fmoc) or trichloro tert-butyloxycarbonyl (TCBOC). In some such embodiments, the spacer molecule's functional group may comprise at least one of a hydroxyl group and an amine group.

In example embodiments, converting the first molecule into a second molecule by removing the acid-labile group from the first molecule may comprise applying a composition for forming an oligomer array to the substrate to form a layer thereon and removing the acid-labile group from the first molecule to convert the first molecule into a second molecule. In some such embodiments, the composition comprises an acid stable polymer comprising repeating units represented by Chemical Formulae 1 and 2, a photoacid generator and an organic solvent, and the acid-labile group is removed from the first molecule by exposing the layer to light. The layer may be removed from the substrate using an organic solvent, such as acetonitrile, ethyl acetate, tetrahydrofuran or acetone.

In example embodiments, a chemical bond may be formed between the second molecule and a third molecule. In some such embodiments, the third molecule may comprise an acid-labile group. The third molecule may comprise, but is not limited to, a phosphoramidite, a nucleotide, a ribonucleotide, an amino acid, a monosaccharide, a PNA monomer, an LNA monomer, a GNA monomer, a TNA monomer or any combination thereof.

In accordance with another aspect of the inventive concept, a method of forming an oligomer array may comprise:
(a) attaching a first molecule comprising an acid-labile group to a substrate,
(b) applying a composition for forming an oligomer array to the substrate to form a layer thereon,
(c) exposing the layer to light to convert the first molecule to a second molecule by removing the acid-labile group from the first molecule,
(d) removing the layer,
(e) forming a chemical bond between the second molecule and a third molecule comprising an acid-labile group, and
(f) repeating steps (b) through (e).
   The composition may include an acid-stable polymer comprising repeating units represented by Chemical Formulae 1 and 2, a photoacid generator and an organic solvent. Steps (b) through (e) may be repeated n times to form oligomers on the substrate (e.g., the third molecule may be converted into a fourth molecule and reacted with a fifth molecule comprising an acid-labile group, which may be converted into a sixth molecule and reacted with a seventh molecule comprising an acid-labile group, etc.). In some embodiments, N is a positive integer between about 1 and about 100.

### BRIEF DESCRIPTION OF THE DRAWINGS

The foregoing and other aspects, features and advantages of the present invention will be apparent from the following detailed description taken in conjunction with the accompanying drawings, in which:

FIG. 1 is a flow chart illustrating a method of forming an oligomer array on a substrate in accordance with example embodiments.

FIGS. 2 to 8 are mimetic diagrams illustrating a method of forming an oligomer array including oligonucleotides or analogues thereof in accordance with example embodiments.

FIG. 9 is a graph showing the flourescence intensity of exposed and unexposed portions of substrates having monomers attached thereto.

FIG. 10 is a graph showing the flourescence intensity of an exposed and an unexposed portion of a substrate having oligomers attached thereto.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms “first,” “second,” “third,” etc. may be used herein to describe various elements, components, regions, layers and/or sections, such elements, components, regions, layers and/or sections are not limited by those terms. The terms are used only to distinguish one element, component, region, layer or section from another element, component, region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “oligomer” refers to a molecule comprising a plurality of monomers. For example, an oligomer may comprise about 2 to about 50 monomers.

As used herein, the term “oligomer array” refers to one or more oligomers attached to a substrate.

Hereinafter, example embodiments of the inventive concept will be explained in detail, with reference to the accompanying drawings.

### Compositions for Forming an Oligomer Array

A composition for forming an oligomer array may include an acid-stable polymer, a photoacid generator and an organic solvent. The composition may be used for forming oligomers, such as peptides, oligonucleotides, analogues of oligonucleotides, oligoribonucleotides, analogues of oligoribonucletides, oligosaccharides, oligomers of PNA, LNA, GNA or TNA, etc., on a substrate without damaging the oligomers. The coating characteristics of the composition may be enhanced by controlling the viscosity thereof.

In example embodiments, the composition may comprise an acid-stable polymer comprising repeating units represented by Chemical Formulae 1 and 2. Such a polymer may be highly soluble in an organic solvent, may have a low absorbance and may control the diffusion length of an acid generated by the photoacid generator. Thus, when a layer formed using a composition comprising such a polymer is exposed to light, the light may be selectively absorbed by the photoacid generator in the composition, and the diffusion length of the acid generated by the photoacid generator may be controlled.

In preferred embodiments, the polymer does not comprise functional groups that generate protons (H⁺) or that are unstable to acid. If the polymer includes functional groups that may generate protons, such as a carboxylic group, acid may be generated in the absence of an exposure to light. Consequently, oligomers may be formed at an undesired position on the substrate (i.e., one corresponding to an unexposed portion of the layer). If the polymer includes functional groups that are unstable to acid, the acid generated from the photoacid generator may react with the polymer and not with the materials attached to the substrate. That is, competition between the polymer and the materials attached to the substrate may occur, thereby decreasing the efficiency of the overall process.

As noted above, the polymer may control a diffusion length of acid generated by the photoacid generator, such that oligomers may be selectively formed at one or more desired positions on the substrate. If the diffusion length of acid generated by the photoacid generator is not properly controlled, the acid may diffuse to unexposed portions of the layer. Consequently, oligomers may be attached to undesired positions on the substrate.

In example embodiments, the acid generated by the photoacid generator may diffused uniformly throughout the exposed portion(s) of the layer and may not diffuse into any unexposed portion(s) of the layer. Consequently, oligomers are formed only at the desired position(s) on the substrate (i.e., positions corresponding to exposed portions of the layer).

Also as noted above, the polymer may be highly soluble in an organic solvent. Accordingly, the viscosity of the composition may be readily adjusted, and the layer formed using the composition may be easily removed using the organic solvent.

The polymer may have a weight-average molecular weight in a range of about 1,000 g/mol to about 50,000 g/mol and a molecular weight distribution in a range of about 1.0 to about 5.0. For example, the polymer may have a weight-average molecular weight in a range of about 1,500 g/mol to about 10,000 g/mol and a molecular weight distribution in a range of about 1.5 to about 4.0.

The polymer may have a glass transition temperature in a range of about 50° C. to about 180° C. For example, the polymer may have a glass transition temperature in a range of about 90° C. to about 120° C.

The polymer may be represented by Chemical Formula 3. Such a polymer may have a low absorbance and may control the diffusion length of an acid generated by the photoacid generator. Thus, when a layer formed using a composition comprising such a polymer is exposed to light, the light may be selectively absorbed by the photoacid generator in the composition, and the diffusion length of the acid generated by the photoacid generator may be controlled such that oligomers are only formed at the desired position(s) on the substrate. For example, if p is in a range of about 0.1 to about 0.3, q is a range of about 0.2 to about 0.5 and r is in a range of about 0.2 to about 0.5, the polymer may have a low absorbance and the acid generated from the photoacid generator may be diffused to a proper diffusion length. In contrast, if p, q and r are out of the above-mentioned ranges, the acid may be diffused to unexposed portions of the layer, and oligomers may be formed at undesired positions on the substrate.

The polymer may be represented by Chemical Formula 4. Such a polymer may have a low absorbance and may control the diffusion length of an acid generated by the photoacid generator. Thus, when a layer formed using a composition comprising such a polymer is exposed to light, the light may be selectively absorbed by the photoacid generator in the composition, and the diffusion length of the acid generated by the photoacid generator may be controlled such that oligomers are only formed at the desired position(s) on the substrate. For example, if p is in a range of about 0.1 to about 0.3, q is a range of about 0.2 to about 0.5 and r is in a range of about 0.2 to about 0.5, the polymer may have a low absorbance and the acid generated from the photoacid generator may be diffused to a proper diffusion length. In contrast, if p, q and r are out of the above-mentioned ranges, the acid may be diffused to unexposed portions of the layer, and oligomers may be formed at undesired positions on the substrate.

In example embodiments, the composition may comprise a photoacid generator that efficiently produces a large quantity of acid when exposed to light, thus facilitating the removal of acid-labile groups from molecules attached to the substrate. Accordingly, the composition may be used for forming oligomers on the substrate without damages.

The photoacid generator may be sensitive to light having a wavelength in a range of about 180 nm to about 500 nm. That is, the photoacid generator may be easily react with light having a long wavelength to generate acid. Thus, oligomers (or analogues thereof) may be formed on the substrate without damaging the oligomers (or analogues thereof). For example, the photoacid generator may easily generate acid by I-line having a wavelength of about 365 nm.

The photoacid generator may be represented by Chemical Formula 5.

The photoacid generator may be represented by Chemical Formula 6. Such a photoacid generator may comprise a sulfonate group and/or a nitrile group. Bulky groups, such as sulfonate groups, may prevent acid generated by the photoacid generator from diffusing to unexposed portions of the layer. Nitrile groups may allow the photoacid generator to generate acid using light having a long wavelength, such as I-line.

In example embodiments, the composition may comprise an organic solvent comprising propylene glycol monomethyl ether acetate, propylene glycol ether, cyclohexanon, ethyl lactate, butyl lactate, 1,4-dioxane, dichloromethane, ethyl acetate, acetonitrile, ethyl ether and any combination thereof. For example, the organic solvent may comprise propylene glycol monomethyl ether acetate and/or propylene glycol ether.

In example embodiments, the composition may include about 1 to about 20% by weight of the polymer and about 1 to about 20% by weight of the photoacid generator. When the composition includes about 1 to about 20% by weight of the polymer, the polymer may be easily dissolved in the organic solvent, and the composition may have a viscosity that is suitable for uniformly coating the substrate. If the composition includes less than about 1% by weight of the photoacid generator, too little acid may be generated and the acid-labile groups may not be easily removed from the molecules attached to the substrate. If the composition includes more than about 20% by weight of the photoacid generator, too much acid may be generated and the acid may diffuse to unexposed portions of the layer. Furthermore, if the composition includes more than about 20% by weight of the photoacid generator, the solubility of the polymer may be decreased and the viscosity of the composition may not be suitable for uniformly coating the substrate. In some such example embodiments, the composition may include about 1 to about 10% by weight of the polymer and about 1 to 10% by weight of the photoacid generator.

As described above, the composition may include the photoacid generator having a high absorbance and an acid-stable polymer having a low absorbance and a high solubility in an organic solvent. When an exposure process is performed using light having a long wavelength, the light may be absorbed selectively by the photoacid generator in the composition to generate acid efficiently. Thus, oligomers may be formed on the substrate without being damaged. Moreover, the diffusion length of the acid generated by the photoacid generator may be controlled such that oligomers are selectively formed at one or more desired positions on the substrate.

Methods of forming an oligomer array using a composition of the present invention will be described in more detail, hereinafter, with reference to the accompanying drawings.

### Methods of Forming an Oligomer Array

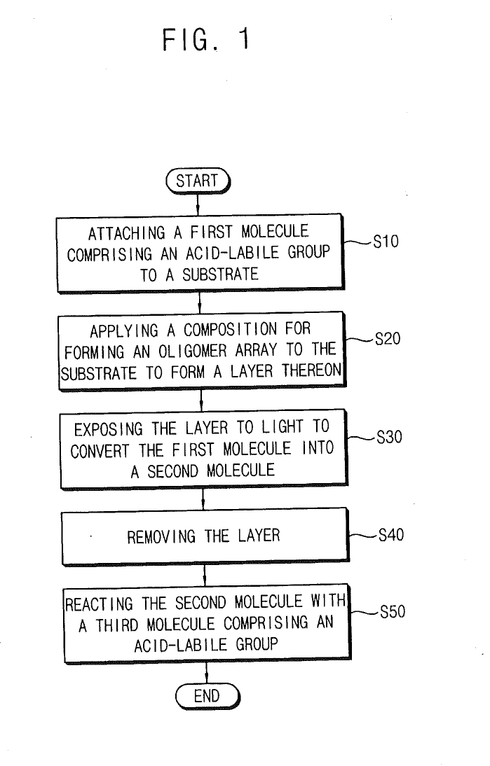

FIG. 1 is a flowchart illustrating a method of forming an oligomer array in accordance with example embodiments. The method described with reference to FIG. 1 may also be applied for forming a polymer array.

Referring to FIG. 1, in step S10, a first molecule comprising an acid-labile group may be attached to a substrate. The substrate may be insoluble in organic solvents and may have a surface suitable for fixing a molecular layer that includes polymers or acid-labile groups. The substrate may have a planar or curved surface.

In example embodiments, the substrate may include silicon, a surface modified glass, polypropylene or activated acrylamide. For example, the substrate may be a silicon substrate. In some such embodiments, when the substrate is a silicon substrate, a silicon oxide layer may be formed on the substrate by a heat treatment.

In example embodiments, the first molecule comprising the acid-labile group may comprise, but is not limited to, a phosphoramidite, a nucleotide, a ribonucleotide, an amino acid, a monosaccharide, a PNA monomer, an LNA monomer, a GNA monomer, a TNA monomer or any combination thereof.

In example embodiments, the acid-labile group may comprise DMT, triphenylmethyltrityl, tert-butyloxycarbonyl or any combination thereof.

As noted above, the first molecule comprising an acid-labile group may be attached to the substrate directly or indirectly.

In example embodiments, the first molecule comprising the acid labile group may be directly attached to the substrate.

In some such embodiments, a linker molecule—comprising a first functional group by which the linker molecule may be attached to the substrate and a second functional group by which the linker molecule may be reacted with another molecule—may be attached to the substrate. A molecule comprising an acid-labile group may be reacted with the linker molecule's second functional group to convert the linker molecule into the first molecule comprising the acid-labile group.

In some such embodiments, a linker molecule—comprising a first functional group by which the linker molecule may be attached to the substrate and a second functional group by which the linker molecule may be reacted with another molecule—may be attached to the substrate. The linker molecule may be reacted with a spacer molecule comprising a third functional group that may be reacted with the second functional group of the linker molecule, a fourth functional group that may be reacted with another molecule (e.g., a molecule comprising an acid-labile group) and a light-labile functional group that may be removed upon exposure to light. Removal of the light-labile group from the spacer molecule may expose its fourth functional group. A molecule comprising an acid-labile group may be reacted with the spacer molecule's fourth functional group to convert the linker-spacer molecule into the first molecule comprising the acid-labile group.

In example embodiments, a linker and/or spacer molecule may be interposed between the first molecule comprising the acid-labile group and the substrate.

In some such embodiments, a linker molecule—comprising a first functional group by which the linker molecule may be attached to the substrate and a second functional group by which the linker molecule may be reacted with another molecule—may be attached to the substrate. The first molecule comprising the acid-labile group may be attached to substrate by forming a chemical bond between the second functional group of the linker molecule and the first molecule comprising the acid-labile group.

In some such embodiments, a linker molecule—comprising a first functional group by which the linker molecule may be attached to the substrate and a second functional group by which the linker molecule may be reacted with another molecule—may be attached to the substrate. The linker molecule may be reacted with a spacer molecule comprising a third functional group that may be reacted with the second functional group of the linker molecule, a fourth functional group that may be reacted with another molecule (e.g., a molecule comprising an acid-labile group) and a light-labile functional group that may be removed upon exposure to light. Removal of the light-labile group from the spacer molecule may expose its fourth functional group. The first molecule comprising the acid-labile group may be attached to the substrate by forming a chemical bond between the exposed fourth functional group of the spacer molecule and the first molecule comprising the acid-labile group.

In example embodiments, the linker molecule may comprise aminoalkyl carboxylic acid, hydroxy alkylaminooxy silane, or aminoalkyloxy silane. For example, the linker molecule may comprise omega-aminocaproic acid or aminopropylethoxy silane.

In example embodiments, the light-labile group of the spacer molecule may comprise a functional group of which a linking bond is easily broken when exposed to light. The light-labile group may be easily substituted with hydrogen.

In example embodiments, the light-labile group of the spacer molecule may comprise NPPCC, McNPOC, o-nitrophenylcarbonyl, p-phenylazophenylcarbonyl, phenylcarbonyl, p-chlorophenylcarbonyl, Fmoc, TCBOC or any combination thereof.

In step S20, a composition for forming an oligomer array may be applied to the substrate to which the first molecule comprising the acid-labile group is attached to form a layer thereon. The layer may be soluble in one or more organic solvents.

In example embodiments, the composition may include a polymer, a photoacid generator and an organic solvent. The polymer may be stable to acid and may comprise repeating units represented by Chemical Formulae 1 and 2.

In example embodiments, the polymer may be presented by Chemical Formula 3 or Chemical Formula 4.

In example embodiments, the photoacid generator in the composition may easily generate acid upon exposure to light having a long wavelength. Thus, oligomers may be formed on the substrate using biomolecules and analogues thereof without deformations or damages thereto. The acid generated by the photoacid generator may have a diffusion length such thatoligomers may be formed at one or more desired positions on the substrate.

In example embodiments, the photoacid generator may be represented by Chemical Formula 5 or Chemical Formula 6.

In example embodiments, the substrate may be coated by a spin coating process to form a layer having a thickness in a range of about 0.1 μm to about 0.5 μm. However, the thickness of the layer and methods of forming the layer may not be limited thereto.

In example embodiments, a pre-baking process may be performed on the layer at a temperature in a range of about 30° C. to about 110° C. for about 20 seconds to about 2 minutes.

In step S30, the first molecule may be converted into a second molecule by exposing the layer to light, thereby removing the acid-labile group from the first molecule.

As noted above, the layer formed by the composition for forming an oligomer array may include a photoacid generator represented by Chemical Formula 5. When the layer is exposed to light, the photoacid generator may generate acid, i.e., protons (H). The protons may make contact with the first molecule, and the acid-labile group of the first molecule may be removed by the protons. As a result, the first molecule may be converted into a second molecule comprising a functional group that may be reacted with another molecule. Accordingly, after removing the layer, the second molecule may be attached to the substrate.

In example embodiments, the layer may be exposed to light having a wavelength of about 180 nm to about 500 nm. For example, the layer may be exposed to Mine having a wavelength of about 365 nm, a krypton fluoride (KrF) laser having a wavelength of about 248 nm or an argon fluoride (ArF) laser having a wavelength of about 193 nm. As discussed above, the composition may have a low absorbance, however, the photoacid generator may have a good absorbance so that the acid may be generated easily from the photoacid generator by light having a long wavelength. Thus, the molecules attached to the substrate may be prevented from experiencing damage as a result of exposure to short wavelength light.

In example embodiments, the second molecule may include a hydroxyl group or an amine group as the functional group that may be reacted with another molecule. For example, when the molecule comprising an acid-labile group comprises a phosphoramidite, a nucleotide or a ribonucleotide, the functional group of the second molecule may comprise a hydroxyl group. When the molecule comprising an acid-labile group comprises an amino acid or a monomer of PNA, the functional group of the second molecule may comprise an amine group.

In example embodiments, a mask may be placed over the substrate prior to the exposure process so that the layer may be selectively exposed to the light, thereby forming exposed and unexposed portions. In some such embodiments, a first molecule attached to the substrate in a position that corresponds to an exposed portion of the layer will be converted into a second molecule, while a first molecule attached to the substrate in a position that corresponds to an unexposed portion of the layer will not be converted into a second molecule. Thus, the unexposed portion(s) may comprise a first molecule (which still has an intact acid-labile group protecting an underlying functional group), and the exposed portion(s) may comprise a second molecule (whose functional group have been exposed by the removal of an acid-labile group).

In step S40, the layer formed by the composition for forming an oligomer array may be removed to expose the first or the second molecule on the substrate.

In example embodiments, the layer may be removed using an organic solvent. In some such embodiments, the layer may be removed using an aprotic solvent comprising acetonitrile, ethyl acetate, tetrahydrofuran, acetone or any combination thereof.

The layer may be easily dissolved by the aprotic solvent to be removed efficiently without remaining residues on the substrate.

In step S50, the second molecule may be reacted with a third molecule.

As noted above, the second molecule may comprise a functional group that is exposed when the acid-labile group is removed from the first molecule. That functional group may be reacted with a third molecule as illustrated above. Thus, the third molecule may be provided on the substrate to combine with the second molecule. Accordingly, monomers composing the oligomers may be attached to the substrate. The first molecule may be attached to the unexposed portion. The third molecule may be selectively reacted with the second molecule because the functional group of the first molecule may be protected by the acid-labile group thereof. Therefore, the third molecule may be attached selectively to a desired position on the substrate.

In example embodiments, the third molecule may include biomolecules or analogues thereof. The third molecule may include biomolecules or synthetic analogues thereof. For example, the third molecule may comprise, but it not limited to, a phosphoramidite, a nucleotide, a ribonucleotide, an amino acid, a monosaccharide, a PNA monomer, an LNA monomer, a GNA monomer, a TNA monomer or any combination thereof.

The third molecule may comprise an acid-labile group. In example embodiments, the acid labile group may comprise DMT, triphenylmethyltrityl or tert-butyloxycarbonyl.

Steps S20 to S50 may be repeated so that an oligomer array may be formed by sequentially attaching molecules to the exposed functional groups of molecules that are already attached to the substrate. Thus, the oligomers attached to the substrate may be prepared to include desired monomers and may be adjusted to have a desired length.

Positions to which the oligomers are attached may be selected variously. According to an example embodiment, the oligomers may be attached to the entire substrate. In this case, the entire substrate may be exposed to light. In another example embodiment, the oligomers may be attached to some portions of the substrate. In this case, the substrate may be partially exposed to light using a mask.

In example embodiments, after forming the oligomer to have a desired number of the monomers, the acid-labile group of the oligomers may be removed.

In example embodiments, the number of the monomers composing the oligomers and the kinds of the oligomers may be adjusted properly. For example, the oligomers may include oligonucleotide, analogues of the oligonucleotide or peptide. The analogues of the oligonucleotide may have a structure similar to nucleotide or ribonucleotide and may include oligomers formed using artificially synthesized monomers.

An oligomer array of the present invention may be applied to a microarray, a biochip, etc. When the oligomer array includes one or more oligonucleotides (or analogues thereof), the oligomer array may be applied to a microarray or a biochip for detecting DNA or RNA having a desired sequence. When the oligomer array includes one or more peptides or proteins, the oligomer array may be applied to a microarray or a biochip for detecting an antibody or an antigen.

As described above, an oligomer array may be formed using a composition of the present invention. The polymer therein may be stable to acid and may comprise repeating units represented by Chemical Formulae 1 and 2 as described above. The composition may have a good sensitivity to long wavelength light so that the oligomer array including biomolecules or analogues thereof may be formed on the substrate without damaging the biomolecules or the analogues thereof.

Methods of forming an oligomer array that includes one or more oligonucleotides (or analogues thereof) will be described in more detail, hereinafter, with reference to the accompanying drawings.

### Methods of Forming an Oligomer Array Including Oligonucleotides or Analogues Thereof

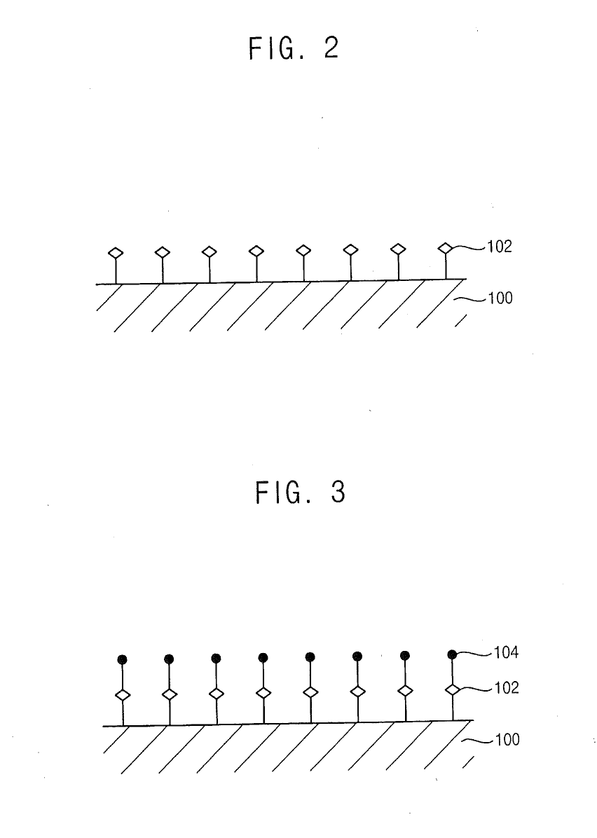

FIGS. 2 to 8 are mimetic diagrams illustrating a method of forming an oligomer array including oligonucleotides or analogues thereof in accordance with example embodiments. However, an oligomer array including peptides, oligosaccharides, oligoribonucleotides or analogues thereof may also have features and advantages of the example embodiments illustrated in FIGS. 2 to 8.

Referring to FIG. 2, linker molecule 102 may be attached to substrate 100.

The substrate 100 may be insoluble in an aprotic solvent and may have a surface that is suitable for fixing molecules comprising a functional group unstable to acid or polymer. For example, substrate 100 may include silicon, a surface modified glass, polypropylene or activated acrylamide.

In example embodiments, substrate 100 may include a planar or a curved surface.

The linker molecule may include a first functional group (not shown) by which the linker molecule may be attached to the surface of substrate 100, and a second functional group (indicated by a symbol, “⋄”) by which the linker molecule may be combined with another molecule.

In example embodiments, the linker molecule may comprise alkyl carboxylic acid, hydroxy alkylaminooxy silane or aminoalkyloxy silane. For example, in some embodiments, the linker molecule may include omega-aminocaproic acid or amino propyltriethoxy silane. In such embodiments, the second functional group ⋄ of linker molecule 102 may include an amine group.

Referring to FIG. 3, a spacer molecule 104 comprising a light-labile group (indicated by a symbol, “”) may be reacted with the second functional group of linker molecule 102 so that spacer molecule 104 may be combined with linker molecule 102.

In example embodiments, when the second functional group of linker molecule 102 includes an amine (—NH₂) group, a hydroxyl (—OH) group of spacer molecule 104 may be reacted with the amine group of linker molecule 102 so that spacer molecule 104 may be combined with linker molecule 102.

In example embodiments, the light-labile group of spacer molecule 104 may comprise NPCC, MeNPOC, o-nitrophenylcarbonyl, p-phenylazophenylcarbonyl, phenylcarbonyl, p-chlorophenylcarbonyl, Fmoc or TCBOC. For example, when oligomers including oligonucleotide or analogues thereof are formed on substrate 100, the light-labile group may comprise methyl-nitropiperonyloxycarbonyl (MeNPOC).

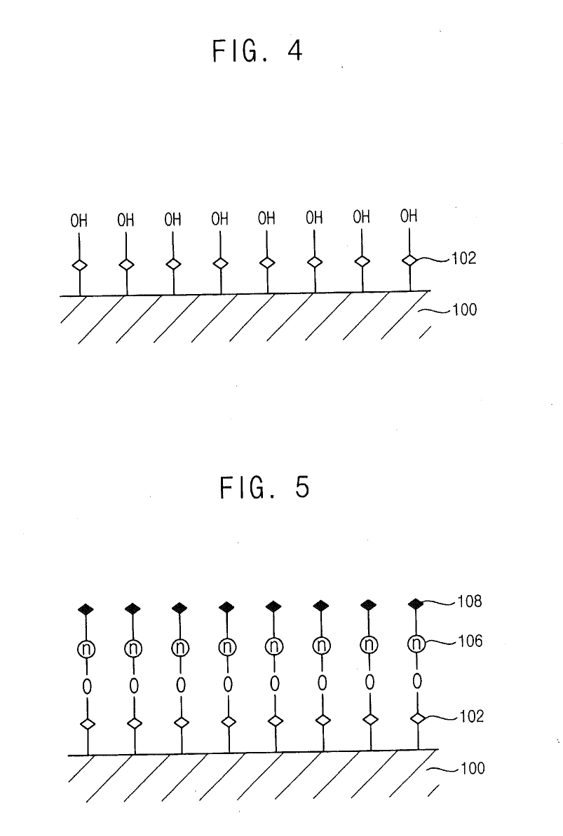

Referring to FIG. 4, the light-labile group of spacer molecule 104 may be removed by exposing the substrate to light, thereby exposing a functional group (indicated by a symbol “OH”) that may be easily reacted with nucleotides or analogues thereof.

In example embodiments, when the light-labile group of spacer molecule 104 includes MeNPOC, MeNPOC may be removed so that a hydroxyl group may be exposed.

Referring to FIG. 5, nucleotide 106 comprising an acid-labile group 108 (indicate by a symbol, “♦”) may be reacted with the functional group OH of spacer molecule 104 so that nucleotide 106 may be combined with linker molecule 102 and spacer molecule 104.

Nucleotide 106 may comprise natural or synthetic compounds, including, but not limited to, natural or synthetic nucleoside, nucleotide, ribonucleoside or ribonucleotide.

Nucleotide 106 may also comprise nucleoside phosphoramidite, ribonucleoside phosphoramidite, a PNA monomer, an LNA monomer, a GNA monomer or a TNA monomer. For example, nucleotide 106 may comprise nucleoside phosphoramidite having bases such as adenine, guanine, cytosine, thymine or uracile.

The acid-labile group 108 of nucleotide 106 may comprise DMT, triphenylmethyltrityl or tert-butyloxycarbonyl.

In example embodiments, when nucleotide 106 comprises nucleoside phosphoramidite or ribonucleoside phosphoramidite, the acid-labile group 108 may include DMT or triphenylmethyltrityl.

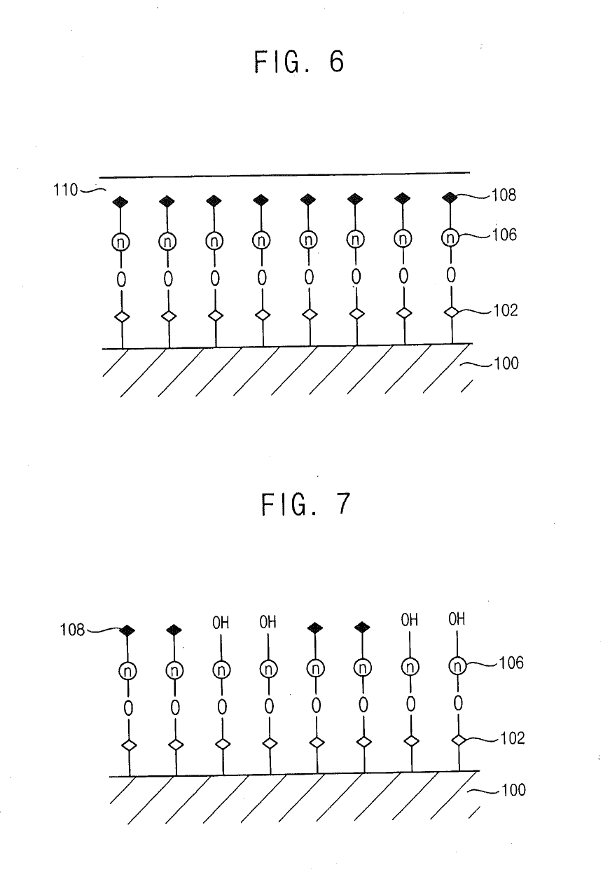

Referring to FIG. 6, a composition for forming an oligomer array may be applied to the substrate 100 to which nucleotide 106 is attached to form layer 110. As described above, the composition may comprise an acid-stable polymer comprising repeating units represented Chemical Formulae 1 and 2, a photoacid generator and an organic solvent.

Layer 110 may be formed by a spin coating process at a rate of about 1,000 rpm to about 4,000 rpm using the composition.

In example embodiments, after forming layer 110 using the composition, a pre-baking process may be performed on layer 110 at a temperature of about 30° C. to about 110° C. for about 20 seconds to about 2 minutes. For example, the pre-baking process may be performed on layer 110 at a temperature of about 90° C. to about 110° C. for about 20 seconds to about 50 seconds.

Referring to FIG. 7, an exposure process may be performed so that the acid-labile group 108 may be selectively removed from nucleotide 106.

In example embodiments, a mask (not shown) may be placed on layer 110 before the exposure process so that portions of layer 110 may be exposed to light while other portions are unexposed to light. Upon exposure to light, the photoacid generator present in exposed portions of layer 110 may generate acid. Acid generated by the exposure process may react with the acid-labile group 108 of nucleotide 106 to expose a functional group (indicated by a symbol “OH”) that may be easily reacted with nucleotides or analogues thereof.

In example embodiments, when nucleotide 106 comprises phosphoramidite or ribonucleoside phosphoramidite, the functional group may comprise a hydroxyl (—OH) group. In other example embodiments, when nucleotide 106 comprises one or more monomers of PNA, the functional group may include an amine (—NH₂) group.

The exposure process may be performed using light having a wavelength of about 180 nm to about 500 nm.

In example embodiments, the exposure process may be performed using light having a wavelength of about 250 nm to about 400 nm. For example, the exposure process may be performed using I-line having a wavelength of about 365 nm. As described above, the photoacid generator in layer 110 may efficiently generate acid upon exposure to light having a long wavelength. Thus, nucleotide 106 may be attached to substrate 100 without being deformed or damaged by exposure to short wavelength light.

In example embodiments, after performing the exposure process, a post-baking process may be performed on layer 110 at a temperature of about 20° C. to about 120° C. for about 5 seconds to about 2 minutes.

Layer 110 may be removed to expose nucleotide 106.

In example embodiments, layer 110 may be removed using an aprotic solvent selected from the group comprising acetonitrile, ethyl acetate, tetrahydrofuran, acetone and any combination thereof. The polymer included in the composition may have a high solubility in the aprotic solvent so that layer 110 may be removed efficiently without remaining residues. For example, layer 110 may be completely removed using acetonitrile.

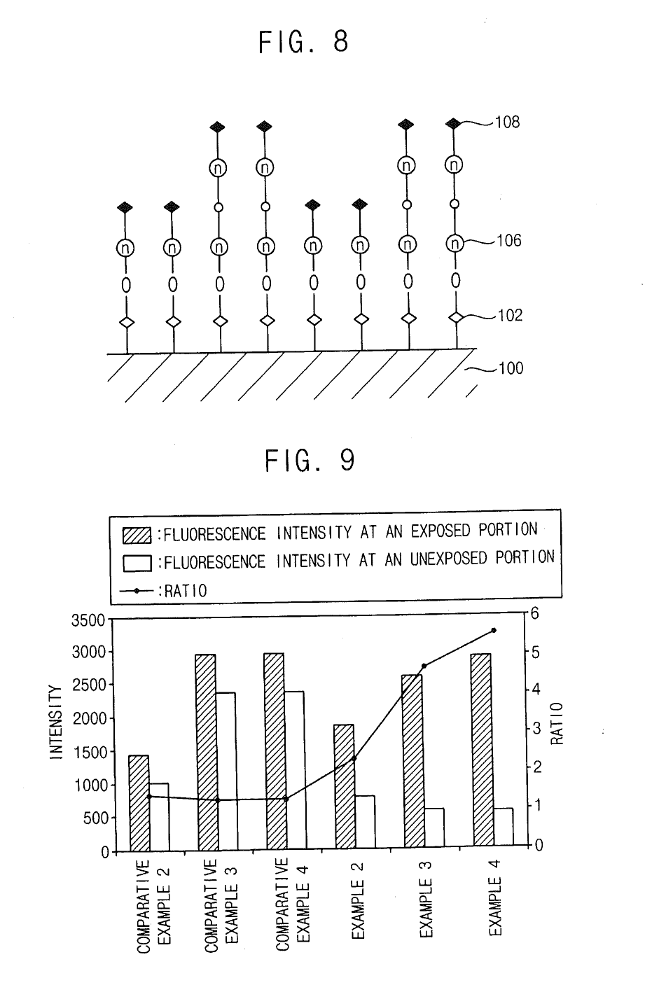

Referring to FIG. 8, when the functional group of nucleotide 106 has been exposed by the removal of acid-labile group 108, nucleotide 106 may be combined with a second nucleotide. That is, a second nucleotide may be attached to those positions on the substrate corresponding to exposed portions of the layer by reacting the second nucleotide with the exposed functional group of nucleotide 106.

Steps of forming a layer, exposing a substrate, removing the layer and adding nucleotides (or analogues thereof) may be repeated to form oligomers comprising the desired number of nucleotides (or analogues thereof) on substrate 100.

In example embodiments, the oligomer array including nucleotide 106 (or analogues thereof) may be applied to biochips or the like. In such embodiments, biochips including the oligomer array may be used for detecting bacteria, diagnosing cancer or diseases, etc.

The nucleotide 106 or analogues thereof may be formed selectively at the exposed portion on the substrate 100 using the composition according to example embodiments. The layer 110 formed by the composition may generate acid efficiently by light having a long wavelength to prevent damages of the nucleotide 106 or analogues thereof by the light. Further, the acid may be diffused uniformly only at the exposed portion so that the nucleotide 106 or analogues thereof may be formed at the desired position on the substrate 100.

Methods of preparing compositions and forming an oligomer array using compositions according to example embodiments of the present invention will be described in greater detail in the following non-limiting Examples.

### Example 1

### Synthesis of Polymer

A flask of about 1 L was purged using nitrogen gas for about 20 minutes. About 5.2 g of norbornene, about 16.8 g of cyclopentyl methacrylate, about 17 g of γ-butyrolactone acrylate, about 2.5 g of dimethyl azobis butylronitrile (DMAB) and about 101 g of 1,4-dioxane were put into the flask, stirred in a nitrogen atmosphere and reacted at a temperature of about 70° C. for about 5 hours. Then, the resulting mixture was cooled to a room temperature. The mixture was added gradually to a solution including ethanol and water with a volume ratio of about 9:1. Then, the solution was filtrated using a porous filter and dried in reduced pressure at a temperature of about 70° C. for about 12 hours to obtain about 22 g of polymer represented by Chemical Formula 7 and having a weight-average molecular weight of about 2,510 g/mol and a molecular weight distribution of about 3.69.

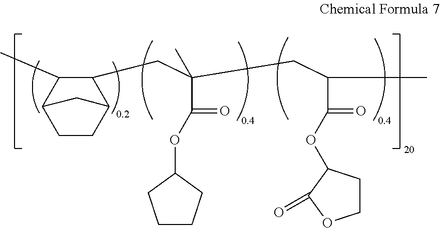

### Preparing a Composition for Forming an Oligomer Array

About 5% by weight of the polymer represented by Chemical Formula 7, about 3% by weight of a photoacid generator represented by Chemical Formula 8 (CGI 1380 manufactured by Ciba Co.) and about 92% by weight of propylene glycol monomethyl ether acetate were mixed to prepare a composition for forming an oligomer array.

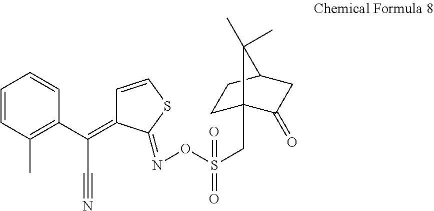

### Attaching Monomers to a Substrate

A silicon oxide layer having a thickness of about 1,000 Å was formed on a silicon substrate having a diameter of about 8 inch by a thermal oxidation process. The substrate having the silicon oxide layer was cleaned using a piranha solution that includes about 70% by weight of sulfuric acid (H₂SO₄) and about 30% by weight of hydrogen peroxide (H₂O₂). A solution including about 2 ml of γ-aminopropyltriethoxysilane, about 180 ml of ethanol and 12 μl of acetic acid was spin coated on the substrate at a rate of about 3,000 rpm. The substrated was washed using ethanol and dried. Then, the substrate was dried in a vacuum condition at a temperature of about 60° C. for about 1 hour to fix amine groups to the silicon substrate.

The substrate having the amine groups was loaded in a DNA synthesizer (manufactured by AMESS Co.). About 70 mg of MeNPOC-TEG-Acid α-methyl-2-nitropiperonyloxycarbonyl-tetraethyleneglycol acid) and about 70 mg of HATU (o-(7-azabenzotriazol-1-yl)-N,N,N′,N′-tetramethyluroniu) were dissolved in about 49 μl of tetraethylamine (TEA) and about 14 ml of acetonitrile to prepare a solution. The solution was injected to the DNA synthesizer and the substrate was stationed in the DNA synthesizer for about 30 minutes. Then, the substrate was washed using about 60 ml of acetonitrile to combine a spacer molecule that includes α-methyl-2-nitropiperonyloxycarbonyl group as a light-labile group and is represented by Chemical Formula 9 to the amine groups.

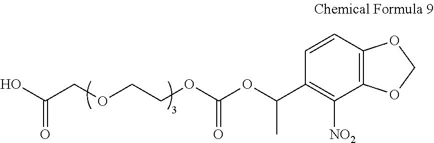

The substrate to which the amine groups combined with the light-labile group were attached was loaded in a stepper (PAS5500 I-line stepper manufactured bay ASLM Co.). The substrate was exposed using I-line having an intensity of about 10 J/cm² to remove α-methyl-2-nitropiperonyloxycarbonyl groups corresponding to the light-labile group. By removing the light-labile group, hydroxyl groups were exposed. Then, the substrate was washed using acetonitrile. The substrate was loaded in the DNA synthesizer. About 2 ml of an aceto nitrile solution having about 0.1M of monomers of N6-Benzoyl-5-O-(4,4-dimethoxytrityl)-2-deoxyadenosine-3-O-[O-(2-cyanoethyl)-N,N-diisopropylphosphoramidite], (DMT-dA (bz) amidite, manufactured by proligo Co.) and about 2 ml of about 0.1M of tetrazol/aceto nitrile solution (Activator 42, manufactured by proligo Co.) were added to the substrate and stirred for about 30 minutes to combine DMT-dA (bz) amidite with the hydroxyl groups exposed on the substrate. Unreacted hydroxyl groups were capped using CAP A and CAP B (manufactured by proligo Co.). Then, an oxidation process was performed using Oxidizer (manufactured by proligo Co.) including pyridine, iodine and deionized water to attach DMT-dA (bz) amidite on the substrate.

### Example 2

### Removing an Acid-Labile Group with 100 mJ/cm² I-Line

The composition for forming an oligomer array of Example 1 was coated on the substrate including DMT-dA (bz) amidite of Preparing Example by a spin-coating process to form a layer, and a pre-baking process was performed on the layer at a temperature of 100° C. for about 30 seconds. Then, a mask was placed on the layer and the layer was exposed using I-line having an intensity of about 100 mJ/cm². After the exposure process, a post-baking process was performed on the layer at a temperature about 100° C. for about 30 seconds. The layer was removed using acetonitrile and dimethyltrityl groups were left from DMT-dA (bz) amidite attached to the substrate to expose hydroxyl groups.

### Example 3

### Removing an Acid-Labile Group with 300 mJ/cm² I-Line

A substrate to which monomers were attached was manufactured by performing processes substantially the same as those of Example 2, except that the layer was exposed using I-line having an intensity of about 300 mJ/cm².

### Example 4

Removing an Acid-Labile Group with 500 mJ/cm² I-Line

A substrate to which monomers were attached was manufactured by performing processes substantially the same as those of Example 2, except that the layer was exposed using I-line having an intensity of about 500 mJ/cm².

### Example 5

### Attaching Additional Monomers to a Substrate

A substrate to which monomers were attached was manufactured by performing processes substantially the same as those of Example 3. The substrate was loaded in the DNA synthesizer again. About 2 ml of an aceto nitrile solution having about 0.1M of DMT-dA (bz) amidite (manufactured by proligo Co.) and about 2 ml of about 0.1M of tetrazol/aceto nitrile solution (Activator 42, manufactured by proligo Co.) were added to the DNA synthesizer and stirred for about 30 minutes to combine DMT-dA (bz) amidite with the hydroxyl groups exposed on the substrate. Unreacted hydroxyl groups were capped using CAP A and CAP B (manufactured by proligo Co.). An oxidation process was performed using Oxidizer (manufactured by proligo Co.) including pyridine, iodine and deionized water to attach DMT-dA (bz) amidite to the hydroxyl groups exposed on the substrate. Then, steps of forming a layer using the composition of Example 2, pre-baking, exposing, post-baking, removing the layer and attaching phosphoramidite were repeated 14 times to form a substrate to which oligomers including 15 units of phosphoramidite were attached at the exposed portion. The steps of forming a layer using the composition of Example 2, pre-baking, exposing, post-baking and removing the layer were performed once again to remove dimethyltrityl groups from the uppermost phosphoramidite and expose the hydroxyl groups. Consequently, an oligomer array was formed at the exposed portion on the substrate.

### Example 6

### Comparative Example 1

About 1.5% by weight of a polymer represented by Chemical Formula 10, about 5% by weight of a photoacid generator represented by Chemical Formula 5 as illustrated above and about 93.5% by weight of propylene glycol monomethyl ether acetate were mixed to prepare a composition.

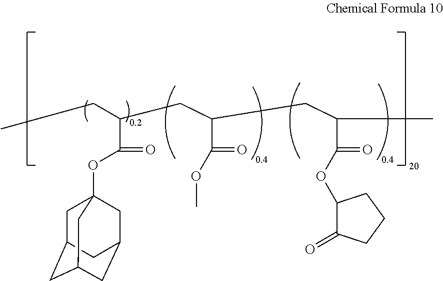

### Example 7

### Comparative Example 2

A substrate including monomers was prepared by substantially the same way as that of Example 2 except for using the composition of Example 6 to form a layer.

### Example 8

### Comparative Example 3

A substrate including monomers was prepared by substantially the same way as that of Example 3 except for using the composition of Example 6 to form a layer.

### Example 9

### Comparative Example 4

A substrate including monomers was prepared by substantially the same way as that of Example 4 except for using the composition of Example 6 to form a layer.

### Example 10

### Evaluation of Compositions for Forming an Oligomer Array

### Experimental Example 1

The substrates prepared in Examples 2 to 4 and Comparative Examples 2 to 4 were treated as follows. Exposed hydroxyl groups were fluorescence labelled using about 1 mM of fluorescein phosphoramidite (manufactured by proligo Co.), then washed using ethanol and dried using nitrogen gas. The fluorescence intensities and the ratio of the fluorescence insensity of exposed/unexposed portions are shown in FIG. 9.

The fluorescence intensities of exposed portions of Comparative Examples 2 to 4 were similar to those of exposed portions of Examples 2 to 4. However, the fluorescence intensities of the unexposed portions of Comparative Examples 2 to 4 were higher than those of unexposed portions of Examples 2 to 4.

In Comparative Examples 2 to 4, the ratio of the fluorescence intensities of the exposed portions to that of the unexposed portions was almost 1:1. That is, in Comparative Examples 2 to 4, dimethyltrityl groups were removed to expose the hydroxyl groups not only of monomers in the exposed portions but also of those in the unexposed portions. Thus, in Comparative Example 1, acid generated at the exposed portion was diffused to the unexposed portion.

In Examples 2 to 4, the ratio of the fluorescence intensities of the exposed portions to that of the unexposed portions was more than 2. That is, the intensities of the exposed portions were more than 2 times than that of the unexposed portions. Thus, in Examples 2 to 4, dimethyltrityl groups were selectively removed from monomers in the exposed portions. Thus, the acid generated in the exposed portions was not diffused to the unexposed portions, and monomers may be attached to a desired position on the substrate by using the composition for forming an oligomer array of Example 1.

### Experimental Example 2

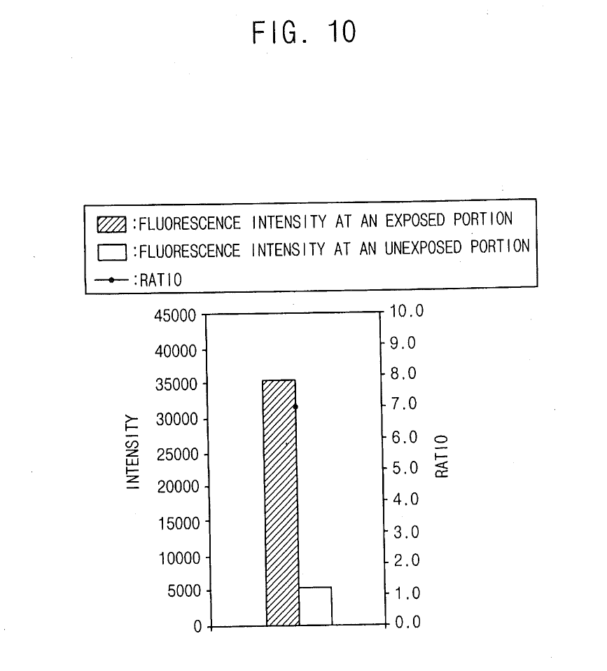

The substrate prepared in Example 5 was treated substantially the same as in Experimental Example 1. The fluorescence intensity and the ratio of the fluorescence insensity of an exposed and an unexposed portion are shown in FIG. 10.

The fluorescence intensity ratio was measured to be more than about 7 when oligomers including a plurality of monomers (15 monomers as seen in Example 5) were formed on the substrate. In other words, dimethyltrityl groups were selectively removed from the uppermost monomer of the oligomer to expose the hydroxyl groups. Thus, the acid generated at the exposed portion was not diffused to the unexposed portion, and the oligomers may be attached to a desired position on the substrate by using the composition of Example 1.

The foregoing is illustrative of example embodiments and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims.

1-8. (canceled)

9. A method of forming an oligomer array, comprising:
attaching a first molecule comprising an acid-labile group to a substrate;
applying a composition for forming an oligomer array to the substrate to form a layer thereon;
converting the first molecule into a second molecule by removing the acid-labile group from the first molecule;
removing the layer; and
forming a chemical bond between the second molecule and a third molecule comprising an acid-labile group.

10. The method of claim 9, wherein the composition comprises an acid-stable polymer comprising repeating units represented by Chemical Formulae 1 and 2, a photoacid generator and an organic solvent, 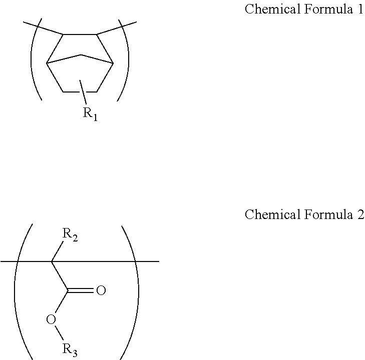
wherein, in Chemical Formulae 1 and 2, R₁ is stable to acid and represents hydrogen, a C₁-C₂₀ alkyl group, a C₃-C₂₀ cycloalkyl group, a C₂-C₂₀ alkoxy alkyl group or a C₅-C₂₀ alkoxy cycloalkyl group; R₂ is stable to acid and represents hydrogen, a C₁-C₂₀ alkyl group or a C₂-C₂₀ alkoxy alkyl group; and R₃ is stable to acid and represents a C₃-C₂₀ cyclo alkyl group or a C₃-C₂₀ lactone group, and
wherein the acid-labile group is removed from the first molecule by exposing the layer to light.

11. The method of claim 9, wherein the third molecule comprising an acid-labile group comprises a phosphoramidite, a nucleotide, a ribonucleotide, an amino acid, a monosaccharide, a PNA monomer, an LNA monomer, a GNA monomer or a TNA monomer.

12. The method of claim 9, wherein attaching the first molecule comprising the acid-labile group to the substrate comprises:
attaching a linker molecule to the substrate; and
reacting the linker molecule with a compound comprising the acid-labile group to convert the linker molecule into the first molecule comprising the acid-labile group.

13. The method of claim 9, wherein attaching the first molecule comprising the acid-labile group to the substrate comprises:
attaching a linker molecule to the substrate;
reacting the linker molecule with a spacer molecule comprising a light-labile group and a functional group capable of forming a chemical bond with the first molecule comprising the acid-labile group;
removing the spacer molecule's light-labile group by exposing the substrate to light, thereby exposing the spacer molecule's functional group; and
forming a chemical bond between the first molecule comprising the acid-labile group and the exposed functional group.

14. The method of claim 13, wherein the light-labile group comprises oxycarbonyl (NPPCC), methyl-nitropiperonyloxycarbonyl (MeNPOC), o-nitrophenylcarbonyl, p-phenylazophenylcarbonyl, phenylcarbonyl, p-chlorophenylcarbonyl, 9-floureneylmethyloxycarbonyl (Fmoc) or trichloro tert-butyloxycarbonyl (TCBOC).

15. The method of claim 13, wherein the functional group of the spacer molecule comprises a hydroxyl group or an amine group.

16. The method of claim 9, wherein the layer is removed using an organic solvent comprising acetonitrile, ethyl acetate, tetrahydrofuran, acetone or any combination thereof.

17. The method of claim 9, wherein the acid-labile group comprises dimethoxytrityl (DMT), triphenylmethyltrityl or tert-butyloxycarbonyl.

18. The method of claim 9, wherein the applying, converting, removing and forming steps are repeated to form a new layer on the substrate, to convert the third molecule into a fourth molecule, to form a chemical bond between the fourth molecule and a fifth molecule comprising an acid-labile group and to remove the new layer.

19. The method of claim 18, wherein the composition comprises an acid-stable polymer comprising repeating units represented by the Chemical Formulae 1 and 2, a photoacid generator and an organic solvent, and
wherein the acid-labile group is removed from the third molecule by exposing the layer to light.

20. The method of claim 19, further comprising repeating the applying, converting, removing and forming steps n times to add additional molecules to the oligomers attached to the substrate.
